(19) United States
(12) Patent Application Publication
(10) Pub. No.: US 2005/0094416 A1
(43) Pub. Date: May 5, 2005

(54) Light source structure

(76) Inventor: Roger W. Schmitz, Hutchinson, MN (US)

Correspondence Address: Robert B. Leonard;Faegre & Benson LLP, 2200 Wells Fargo Center, 90 South Seventh Street, Minneapolis, MN, 55402-3901, US

(21) Appl. No.: 10/698,751

(22) Filed: Oct. 31, 2003

(51) Int. Cl. G02B 6/00

(52) U.S. Cl. 362/551

(57) ABSTRACT

A light source for use in a spectrometer. A reflector is formed with a parabolic holed formed therein. A light emitting diode is placed in the parabolic hole. In the case where multiple LEDs are used in the light source, central axis through each of the parabolic holes are aligned so as to coincide a predetermined location. With LEDs in the parabolic holes, the light emitted will be focused on the predetermined location.

### TECHNICAL FIELD

The present invention relates to the field of light based measurements and more particularly to structures for focusing light on a target.

### BACKGROUND OF THE INVENTION

Spectrometers have gained popularity as a tool for measuring attributes of tissue. By way of illustration only, the operation of an instrument of this type is described briefly with reference to prior art FIG. 1. The instrument 20 included an optical probe 22 that was releasably connected to an electronics package or monitor 24. In operation, the optical probe 22 was positioned on the tissue to be measured or on a calibration device 23. The optical probe 22 was interfaced to the monitor 24 through optical fibers 26 and a probe connector 28. The probe connector 28 included light emitting diodes (LED's) or other light sources for generating light at a number of different wavelengths (see prior art FIG. 2). The light used to measure characteristics of the tissue was coupled to the optical probe 22 by send-optical fibers 26. After being transmitted from the tissue-engaging surface of the optical probe 22 into the tissue being measured, the light traveled through the tissue before being collected at the end of the receive optical fiber 26. The collected light (measurement or sample light signal) was then transmitted to the monitor 24 through the probe connector 28 and monitor connector 30. A reference light signal corresponding to each of the measurement light signals (i.e., the reference light signals are not transmitted through the tissue) was also transmitted to the monitor connector 30. The ends of the optical fibers 26 from the optical probe 22 were typically terminated at ferrules in the probe connector 28. The ferrules were adapted to plug into or otherwise mate with associated connectors (i.e., an optics receptacle mount) in the monitor connector 30. In one embodiment, the probe connector 28 generated a calibration recognition signal at 530 nanometers and measurement light signals at 680, 720, 760 and 800 nanometers.

The collected measurement light signals and reference light signals received by the monitor 24 were transmitted to a detector 32 which produced electrical signals representative of these light signals at each wavelength of interest. A processor/controller 34 then processed these signals to generate data representative of the measured tissue parameter (e.g., saturated oxygen level (StO₂)). The measurement reading could be visually displayed on a display 36. Algorithms used to compute the tissue parameter data were generally known and described in U.S. Pat. No. 5,879,294 (Anderson et al.).

Prior art FIG. 2 is a sectional view of an exemplary probe connector 28 suitable for use in the present invention. As shown, the probe connector 28 included 4 LED's 40, 42, 44, 46 for generating the measurement light signals at 680, 720, 760, and 800 nanometers, respectively. Light signals from each of these LED's 40, 42, 44,46 were coupled to the optical probe 22 by separate measurement signal send fibers 50, 52, 54, 56. Light from a calibration recognition LED 48 was coupled to the optical probe 22 by separate calibration recognition send fiber 58. After being transmitted through the tissue and being collected at the optical probe 22, the measurement light signal is coupled back to the probe connector 28 by a measurement or sample signal receive fiber 59. The end of the measurement signal receive fiber 59 terminated at a sample ferrule fiber terminal 60 located in an interface housing 62. The sample ferrule fiber terminal 60 included a sample ferrule 64 adapted to mate with a socket in the monitor connector 30.

A reference light signal was also provided by the probe connector 28. The reference light signal included a portion of the light from each of the LED's 40, 42, 44, 46. In the embodiment shown in prior art FIG. 2, the reference light signal was collected by a reference light signal send optical fibers 70, 72, 74, 76 that extend from each measurement light signal source LED's 40, 42, 44, 46 to a light mixer 80 formed from a scattering material. Light from the calibration recognition LED 48 was coupled to the light mixer 80 by calibration reference light signal send optical fiber 82. A ferrule 84 is typically used to optically couple the optical fibers 70, 72, 74, 76, 82 to the light mixer 80. The reference light received from each LED 40, 42, 44, 46, 48 was mixed and attenuated at the light mixer 80 and transmitted through the reference signal receive fiber 86 to a reference ferrule fiber terminal 88 located in the interface housing 62. Since light from measurement signal send fibers 40, 42, 44, 46 was transmitted through the tissue, the intensity of the measurement light signal at the sample ferrule 64 is much less than the intensity of the non-attenuated reference light signal at the reference ferrule 94 (e.g., about 1 million times less). This mismatch in signal magnitude required the reference signal to be attenuated in order to measure the light signals with a common detector gain control setting. The reference ferrule fiber terminal 88 included a reference ferrule 94 adapted to mate with a socket in the monitor connector 30.

The interface housing 62 also includes a conventional electrical connector 90 that is electrically coupled to the LED's 40, 42, 44, 46, 48, typically through the use of a printed circuit board 92. The electrical connector 90 includes a plurality of contacts or pins 91. The electrical connector 90 couples with an monitor connector 30 and provides electric power and control signals to the LED's 40, 42, 44, 46, 48. Although the probe connector 28 is illustrated with two output fibers (ferrules 64, 94 ) coupled to the monitor connector, the optical connector latch mechanism could be used for optical connectors with one or more output fibers.

Prior art FIG. 3 illustrates an optical probe 312 which was used in connection with the instrument shown in the Anderson et al. U.S. Pat. No. 5,879,294 and which included a light mixer 310. The probe 312 included an insert 314 for holding a number of optical fibers 316, 318 and 320, a housing 322 into which the insert was mounted and a disposable elastomeric tip (not shown) which was releasably mounted to the housing. The optical fibers 316, 318 and 320, were coupled between the housing 322 and instrument (not shown) within a cable housing 328. The illustrated embodiment of the probe 312 had 4 send fibers 316 through which light of different wavelengths from the instrument (provided by narrow bandwidth LEDs) was transmitted to the probe. The ends of the send fibers 316 were sealed in a ferrule 330. The light mixer 310 was a section of optical fiber located between the fiber ferrule 330 and the tissue-facing surface 326 of the probe 312. The different wavelengths of light emitted from the ends of the send fibers 316 were mixed within the fiber of mixer 310 and thereby scattered throughout the surface area of the fiber at the tissue-facing surface 326. Each wavelength of light thereby traveled through a similar volume of tissue after being transmitted from the probe 312. As shown, a receive fiber 318 and a calibration recognition fiber 320 also had ends which terminated at the tissue-facing surface 326 of the probe 312. The receive fiber 318 collected light that traveled through the tissue being analyzed and transmitted the collected light to the instrument for processing. Light emitted from the calibration recognition fiber 320 was used by the instrument to control a calibration procedure.

The mixer 310 accepted, on its input side, light from the individual send fibers 3-16. The light mixer enhanced the homogeneity of the light emitted on its output side and transmitted to the tissue. The result was that variations (e.g., in intensity) in wavelength of light transmitted from the mixer 310 vs. the position on the output end of the mixer are minimized. All wavelengths of the light entering the tissue were therefore generally equally attenuated by the tissue, since a common entry point into the tissue would not bias any wavelength toward a longer or shorter path length than other wavelengths. Each wavelength of light was scattered over the whole cross-sectional area of the fiber of mixer 310, enabling each wavelength of light to travel through a similar volume of tissue.

In one embodiment of the invention the output end of the mixer 310 was in direct contact with the tissue being measured. A curved segment of optical fiber (e.g., glass or plastic) with a numerical aperture (acceptance angle) greater than that of the send fibers 316 was used for the mixer 310. Both ends of the mixer 310 could be polished clear. The output ends of the send fibers 316 were in near direct contact (e.g., within about 0.025 mm) with the input side of the mixer 310. The output end of the mixer 310 could be polished flat with the probe tip 312. The minimum diameter of the mixer 310 was preferably such that it was larger than the overall packed diameter of the input fibers 316. End faces of the mixer 310 fiber could also be coated with an anti-reflective material to increase throughput.

Referring now to prior art FIGS. 3A and 3B, thereshown is a prior art optical return path for the received light in fiber 318. The reference light signal and measurement light signal (also referred to as a sample light signal) received at the connector at spatially separated paths were collimated by lenses or other optics and directed to a shutter and path-shifting optics 380 (FIG. 3A). The shutter and path-shifting optics 380 selectively and alternately directed or folded the signals into a common path to the detector (optical bench). One embodiment of the prior art shutter and path-shifting optics is illustrated in FIG. 3A. As shown, a 30 degree stepper motor 382 drove opaque vane 384 and was controlled by the processor/controller 34, as indicated by arrow 386. The stepper motor 382 positioned the vane 384 to selectively block one of the reference light signal and measurement light signal, and to transmit the other of signals to the path shifting optics. Arrow 388 indicates a collimated LED reference light path, while arrow 390 indicates a collimated measurement/sample light path (from the probe 12 ).

In the embodiment shown, the path shifting optics included a 45 degree combining (beam splitting) mirror 392 in the measurement light path 394. This combining mirror allowed a significant portion (e.g., 98-99%) of the measurement light signal to pass through the mirror to the detector 32 as indicated by arrow 396, with the remaining amount (e.g., 1-2%) being reflected away from the detector (i.e., trapped, as indicated by arrow 398 ). A 45 degree reflecting mirror 399 in the reference light path 397 reflected the reference light signal onto the side of the combining mirror opposite the side to which the measurement light signal was initially directed. A significant portion of the reference light signal then passed through the combining mirror, while a smaller amount (e.g., 1-2%) was reflected to the detector along the same optical path 396 as the measurement light signal. The measurement light signal and reference light signal were thereby directed or folded onto the same path 396 and directed to a common detector. In response to control signals from the processor/controller 34, the stepper motor 382 positioned the opaque vane 384 to block one of the reference light signal or the measurement light signal. The other of the reference light signal and the measurement light signal was then transmitted to the detector 34. This optics configuration also reduced the intensity of the reference light signal so it would not saturate the PMTs of the detector.

FIG. 3B is an illustration of a detector 34 used with the optical path created by the structure shown in FIG. 3A. An approximate 5 mm diameter collimated light beam indicated by arrow 104 (either from the reference or sample (measurement) light signal) was transmitted to the front surface of an 800 nm dichroic mirror 106 which was positioned 30 degrees from the optical axis 108. Approximately 90% of the light having a wavelength greater than 780 nm was reflected to the first photomultiplier tube (PMT) sensor 110 which had a 800 nm bandpass filter (±10 nm FWHM) positioned in front of the PMT sensor 110. Approximately 80% of the light having a wavelength shorter than 780 nm was transmitted through the 800 nm dichroic mirror 106 to the front surface of a 760 nm dichroic mirror 112 which is positioned 25 degrees from the optical axis 108. Approximately 90% of the light having a wavelength greater than 740 nm was reflected to the second PMT sensor 114 which had a 760 nm bandpass filter (±10 nm FWHM) positioned in front of the PMT sensor 114. Approximately 80% of the light having a wavelength shorter than 740 nm was transmitted through the 760 nm dichroic mirror 112 to the front surface of a 720 nm dichroic mirror 116 which was positioned 30 degrees from the optical axis 108. Approximately 90% of the light having a wavelength greater than 700 nm was reflected to the third PMT sensor 118 which had a 720 nm bandpass filter (±10 nm FWHM) positioned in front of the PMT sensor 118. Approximately 80% of the light having a wavelength shorter than 700 nm was transmitted through the 720 nm dichroic mirror 116 to the front surface of a 680 nm dichroic mirror 120 which was positioned 30 degrees from the optical axis 108. Approximately 90% of the light having a wavelength greater than 660 nm is reflected to the fourth PMT sensor 122 which has a 680 nm bandpass filter (±10 nm FWHM) positioned in front of the PMT sensor 122. Approximately 80% of the light having a wavelength shorter than 660 nm was transmitted through the 680 nm dichroic mirror 120 to a detector block consisting of a 600 nm short pass filter (transmits light from approximately 400 nm to 600 nm) positioned in front of a photo diode detector. This detector was used to measure the presence of ambient light and/or the calibration material recognition signal (530 nm LED emitter).

While the prior art structure for putting light at the surface of the tissue under study worked, high signal losses were encountered in the path between the LEDs and the tissue. Further, significant manufacturing effort and parts costs were incurred to make all of the optical paths required.

Efforts to focus light being emitted from LEDs have existed for some time. U.S. Pat. No. 3,910,701 (Henderson et al.) included a structure for aligning a central axis of multiple LEDs such that the light was focused on a point. U.S. Pat. No. 6,124,937 (Mittenzwey et al.) uses a conical reflector to direct light.

### SUMMARY OF THE INVENTION

The present invention is a reflector for use with a light source, such as a LED. The reflector includes a body and a concave surface. The concave surface is preferably formed as a parabolic hole in the body with a reflective coating covering the concave surface. In one embodiment, multiple concave surfaces are formed in the body. Each of the concave surfaces defines a central axis. The central axes of at least two of the concave surfaces intersect at a common point. Through orientation of the concave surfaces in this way, light from light sources can be directed to a common point. In a further enhancement, a mounting region is formed adjacent to the concave surfaces. The mounting region is formed to support a filter for allowing only selected wavelengths of light to pass therethrough. The mounting region allows for the filter to be mounted at a predetermined angle with respect to the central axis of the concave surface.

In another embodiment, the invention is a reflector-light source structure. Again, the reflector includes a body and a concave surface formed around a central axis. In one embodiment, the concave surface is a parabola or a paraboloid having a shape that can be expressed mathematically as Y=AX². The light source may be a LED and is preferably placed at a distance that is substantially ¼ A along the central axis from a bottom of the concave surface. In a further enhancement, a mounting region is formed adjacent to the concave surfaces. The mounting region is formed to support a filter for allowing only selected wavelengths of light to pass therethrough. The mounting region allows for the filter to be mounted at a predetermined angle with respect to the central axis of the concave surface. In another embodiment, the invention is a light source including a reflector, a LED, a filter and a lens. The lens is used to focus light passing through the filter onto a surface under study or onto a light fiber structure. The light fiber structure may include individual fibers for carrying light to a mixer fiber or the lens may be used to focus light directly onto the mixer fiber.

In yet another embodiment, the invention is a probe head for use in a spectrometer. The probe head includes a connection structure for connecting to a spectrometer, one or more light sources, a reflector for each light source, the reflector having a concave surface for each light source and a mounting surface for a filter, a filter positioned on the mounting surface and one or more light sensors for receiving light from a target of interest. A lens may be used in conjunction with this embodiment to further focus light from the light source.

### BRIEF DESCRIPTION OF THE DRAWINGS

FIG. 1 is a block diagram of a prior art spectrometer.

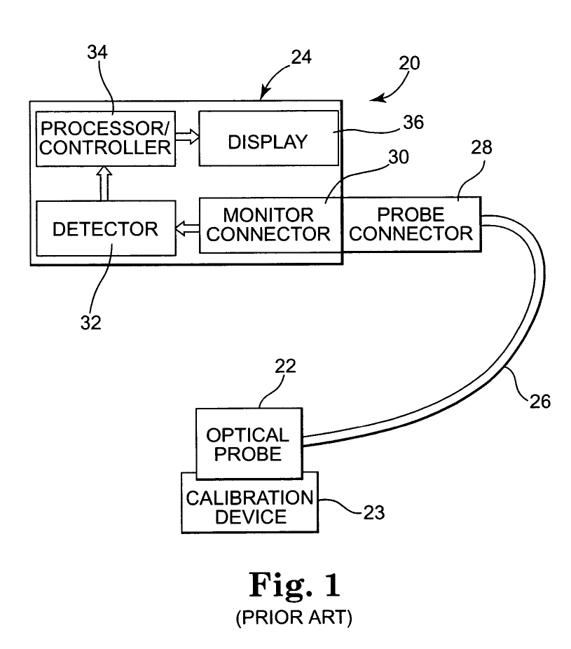

FIG. 2 is a side sectional view of a prior art probe connector of FIG. 1.

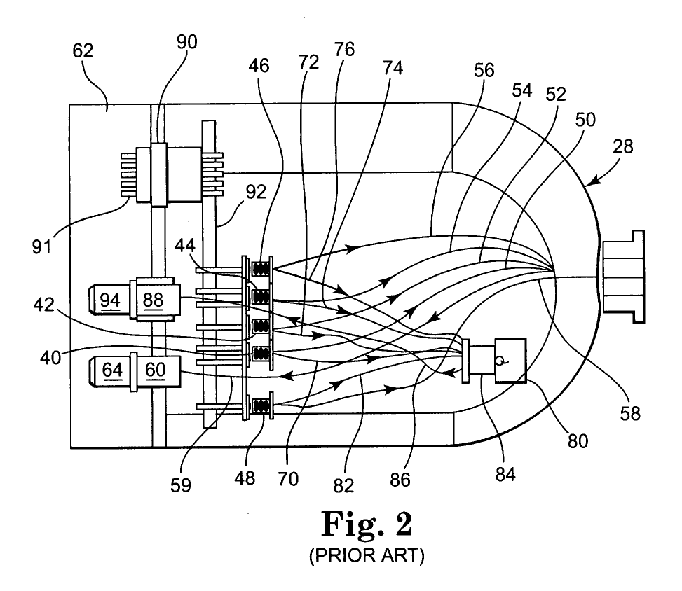

FIG. 3 is a side sectional view of a prior art optical probe of FIG. 1. FIG. 3A is a perspective view of a prior art optical path. FIG. 3B is a side view of a group of photomultiplier tubes.

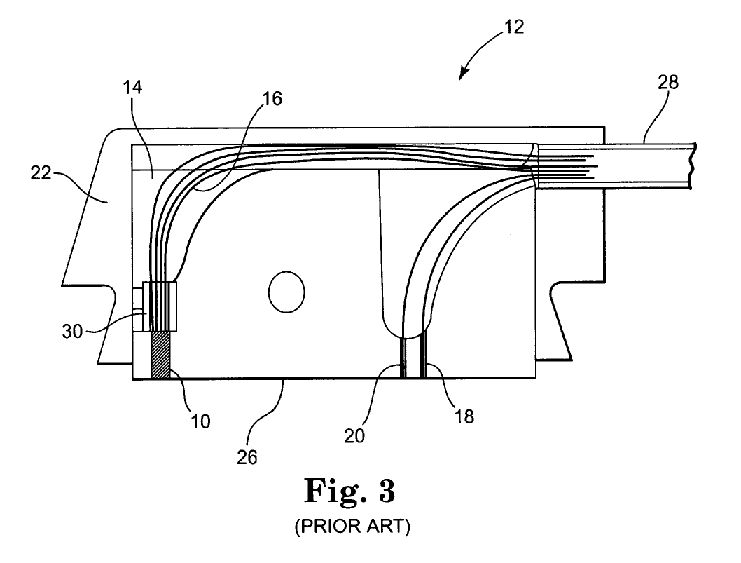

FIG. 4 is a top view of a reflector of the present invention.

FIG. 4A is a sectional view of the reflector of FIG. 4 taken along line 4A-4A.

FIG. 5 is a top view of a second reflector of the present invention.

FIG. 5A is a sectional view of the reflector of FIG. 5 taken along line 5A-5A.

FIG. 5B is a sectional view of the reflector of FIG. 5 taken through parabolic hole 510D.

FIG. 6 is a top view of a reflector-light emitting diode combination.

FIG. 6A is a sectional view of the reflector-light emitting diode combination of

FIG. 6 taken along line 6A-6A.

FIG. 7 is a side view of the reflector-light emitting diode combination of FIG. 6.

FIG. 8 is a combination plan view and schematic of an inventive probe head incorporating the reflector-light emitting diode combination. FIGS. 8A and 8B are combination plan views and schematics of the probe head incorporating the structure of FIGS. 17 and 18 respectively.

FIG. 9 is a combination plan view and schematic of a second inventive probe head incorporating the reflector-light emitting diode combination. FIGS. 9A and 9B are combination plan views and schematics of the probe head incorporating the structure of FIGS. 17 and 18 respectively.

FIG. 10 is an exploded view of a light emitting diode, reflector and a band pass filter in an arrangement according to the present invention.

FIG. 11 is an exploded view of the light emitting diode within a reflector.

FIG. 12 is a perspective view of a reflector for four light emitting diodes.

FIG. 13 is top view of another light source according to the present invention.

FIG. 14 is sectional perspective view of a portion of the light source of FIG. 13.

FIG. 15 is a bottom perspective view of the reflector of FIG. 13.

FIG. 16 is a top perspective view of the circuit board of FIG. 13.

FIGS. 17 and 18 are schematic views of two different light paths from the LEDs to a mixer fiber.

### DETAILED DESCRIPTION OF THE INVENTION

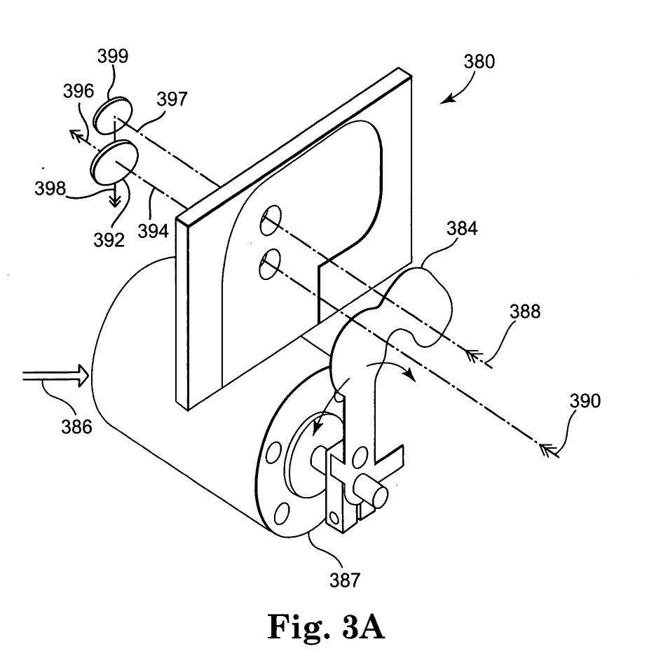

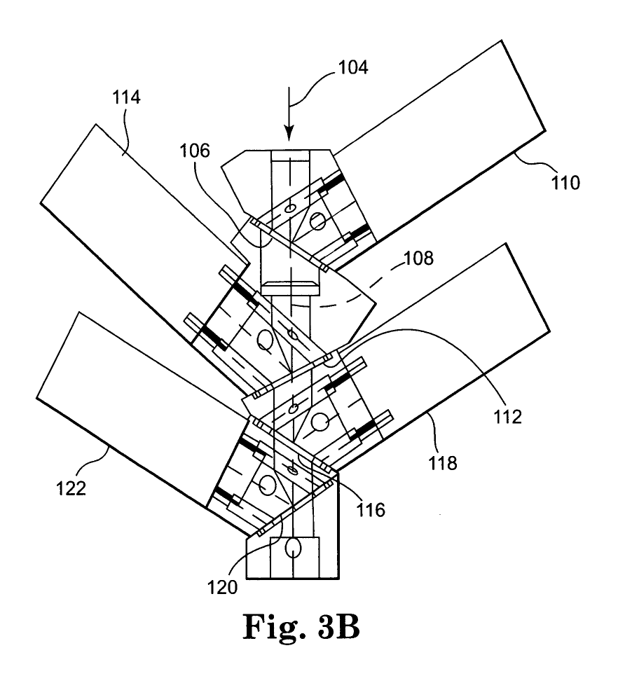

Referring now to FIGS. 4 and 4A, thereshown is a reflector 400 of the present invention. Reflector 400 has a body 405, a parabolic hole 410 with an aperture 415. While the term parabolic is commonly used to describe the shape of such a hole, the term paraboloidic or paraboloid may also be used. For simplicity, we define parabolic to mean both a parabola and a paraboloid. Body 405 is in one embodiment made of a reflective material such as aluminum. In another embodiment, body 405 may be formed by molding, such as through use of a molten metal mold. In yet another embodiment, body 405 may be formed using an injection molded plastic with hole 410 coated with gold, aluminum, silver or other common reflective coating. Parabolic hole 410 and aperture 415 may then be formed using for example, a numerical controlled machine tool. The reflector may also be formed in many other well known ways such as being stamped, formed, drawn or forged out of a reflective material. The mathematical expression of the shape of the hole is y=Ax². The centroid of the LED is preferably placed at the parabolic reflector focal length, which is typically ¼ A. The ratio of a parabola focal length to the LED size will determine the divergence of the collimated beam. A bigger ratio will result in smaller divergence (smaller divergence is better collimation). The following table of modeled data illustrates this:

| LED | Parabolic Reflector | Half Angle |
|---|---|---|
| Size(mm) | Focal Length(mm) | Divergence(degrees) |
| .3 × .3 × .15 | .375 | 18.1 |
| .3 × .3 × .15 | .5 | 13.8 |
| .3 × .3 × .15 | .75 | 9.4 |
| .3 × .3 × .15 | 1.0 | 7.1 |
| .3 × .3 × .15 | 1.5 | 4.8 |
| .3 × .3 × .15 | 2.0 | 3.6 |

The body may be formed to have first and second major surfaces 420, 425. While flat major surfaces are shown, other shapes would also fall within the spirit of the invention.

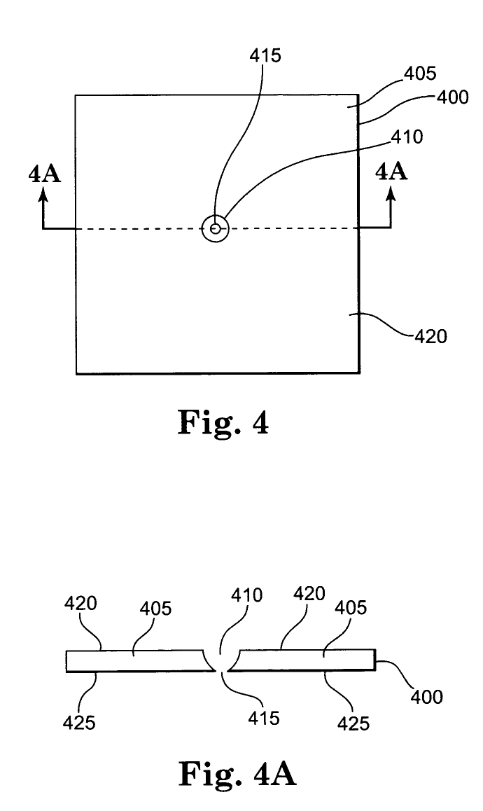

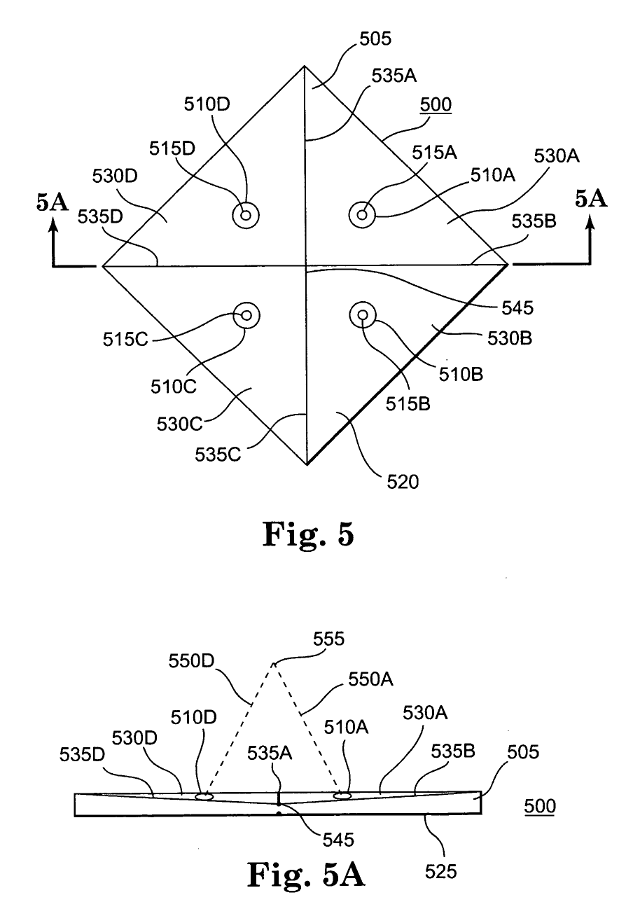

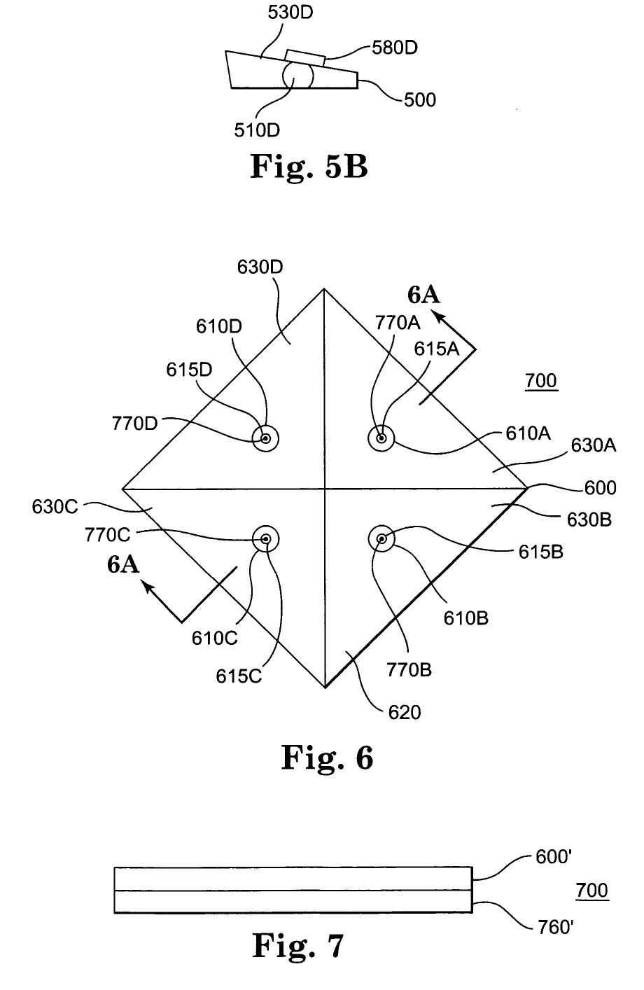

Referring now to FIGS. 5 and 5A, thereshown is a reflector 500 of the present invention that is structured for four LEDs. Body 505 has parabolic holes 510A-D with apertures 515A-D. Each parabolic hole has a central axis around which the parabola is formed. The axes of the four parabolic holes are oriented so that they intersect at point 555. As with the reflector of FIG. 4, the reflector may be made of a reflective material or a non-reflective material with the holes coated with a reflective material and the reflector may be formed through use of a mold or a numerical controlled machine.

Reflector 500 also includes mounting features 530A-D formed on major surface 520. The mounting features in the present embodiment are formed as triangles, but other shapes would work as well. The mounting features 530A-D may be separated from each other by boundaries 535A-D. The boundaries may meet at a center point 545 of reflector 500. The main purpose of the mounting features is to provide a stable mounting surface for interference filters 580 used with the LEDs (see FIG. 5B). In FIG. 5A, axis 550A and D are shown running through parabolic holes 510A and D. The parabolic holes are formed through use of a numerical controlled machine cutting away portions of major surface 520. In one embodiment, the axes of the parabolas of the parabolic holes are normal to the surface of the mounting feature they are located in

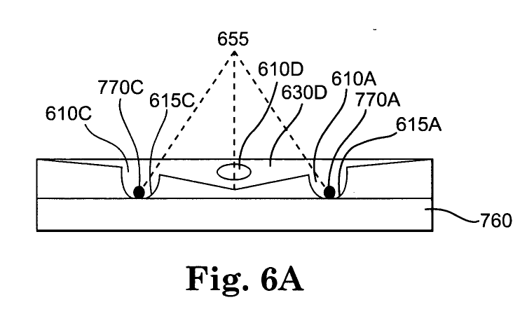

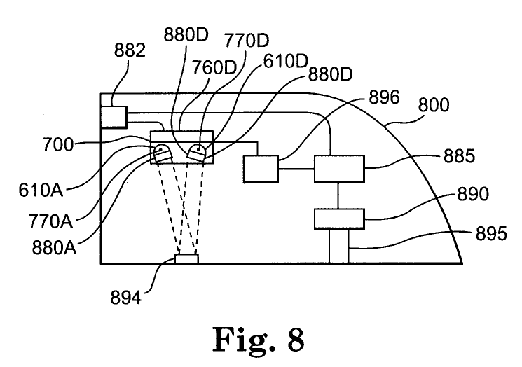

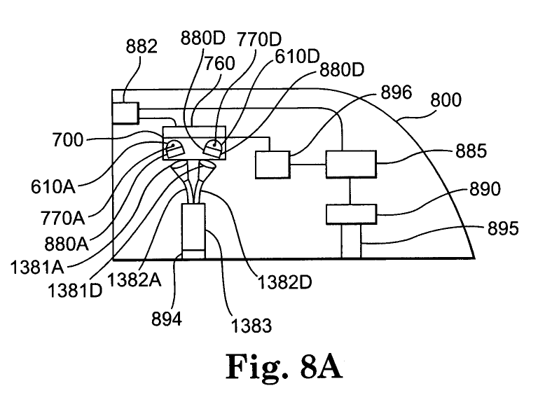

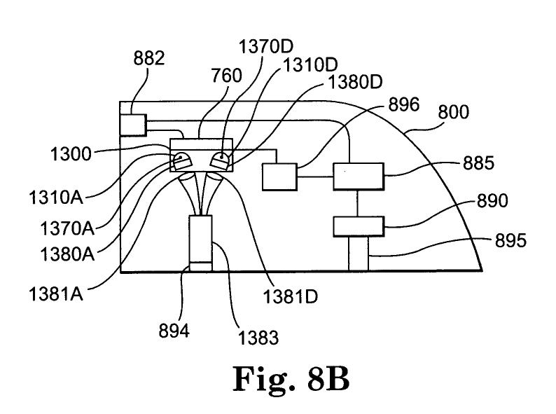

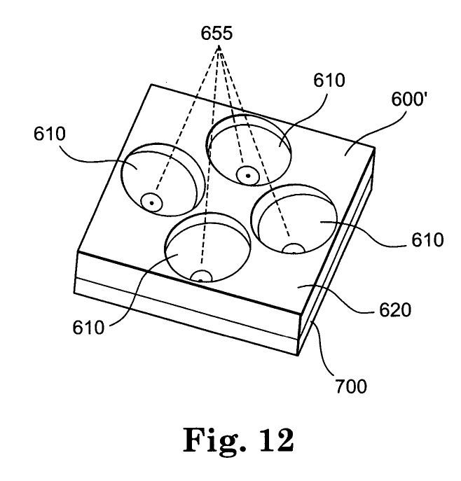

Referring now to FIGS. 6, 6A and 7, thereshown is a light source 700 according to the present invention. The light source includes the reflector 600, LEDs 770A-D and the LED holder 760. LEDs 770A-D are positioned in parabolic holes 610A-D and held in position by LED holder 760. In a preferred embodiment, the top of the LED is positioned at the focal point with respect to the bottom of the parabola and the LED holder is a circuit board on which the LED is mounted. This structure will produce a substantially collimated beam of light. To filter out light that is not collimated well with the collimated beam, an aperture at a sufficient distance from the reflector, may be used. The point of intersection of the parabolic axes is one acceptable location for the aperture. Again, as in FIG. 5, the parabolic holes and the triangular mounting features are formed so that the central axes running through the parabolic holes intersect at a point a predetermined distance from the major surface 620. In one embodiment, the point is located one inch from the major surface and on the same side as the major surface. FIG. 12 shows a perspective view of the light source 700. Note the convergence of the axes at point 655.

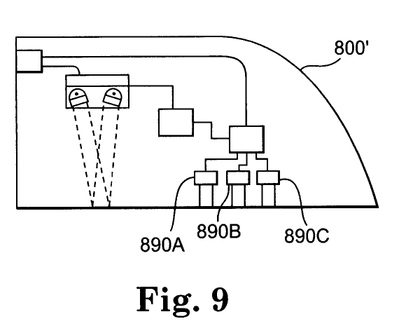

Referring now to FIG. 8, thereshown is a probe head 800 for use in a spectrometer. The probe head includes light source 700, exit aperture 894, light sensor 890 and filters 880A and D and connection 882. The light source is arranged such that the LEDs (770A-D, only 770A and D are shown) are directed to emit light toward aperture 894. The parabolic holes 610 increase the amount of light reaching the aperture. Filters 880 (which may be placed in the light path of all of the LEDs) are in one embodiment, the filters only allow certain wavelengths of light of interest to pass. The light source may be connected to connection 882 to receive a power signal and/or a power control signal to modulate the LEDs.

Light sent from the light source is transmitted through the aperture 894 into a target of interest (e.g. human tissue) and received at light sensor 890 through aperture 895. In one embodiment, the light sensor is a photodiode. The photodiode transduces the light signal into an electrical signal which is then used by unit 885. Unit 885 can be a analog to digital converter which then passes a signal via connection 882 to a processor for processing a signal representative of a measured value, such as blood hemoglobin. In another embodiment, unit 885 may be a processor with either an internal or external analog to digital converter that determines a desired value on the probe head itself.

Connector 882 may be an electrical connector an optical connector, a combination of the two or a wireless link such as an RF link, an IR link or other wireless communications scheme. The connector is used to communicate between the probe head and the spectrometer. In the case where a wireless connector is used, power supply 896 may be used with the probe head to provide on board power. The power supply may be such as a battery, fuel cell, capacitor, solar cell or the like.

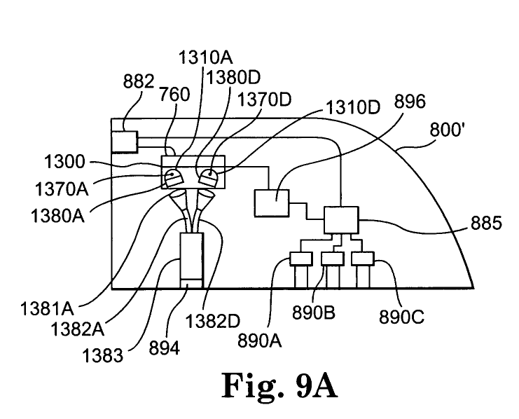

FIG. 9 shows a probe head 800′ that is similar to the probe head 800 of FIG. 8. In FIG. 9, three light sensors are shown. This would allow for measurement of multiple light paths through tissue. Such measurements would allow for determination of the location of and the amount of variation of hemoglobin distribution in the tissue. Further, it can also be used to determine the size and location of other structures in the body, such as tumors.

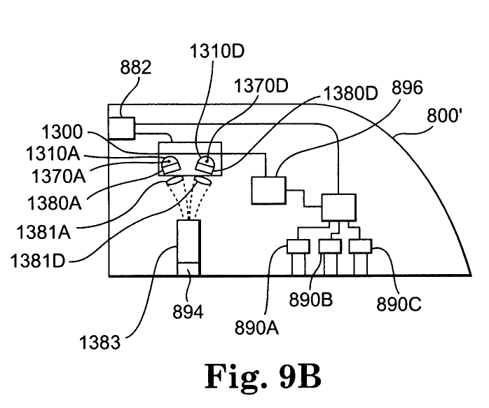

Referring now to FIG. 10, thereshown is an exploded view of a LED 770 with a filter 880 and a parabolic hole 610. In one embodiment, the filter 880 completely covers the opening of the parabolic hole between the LED and the aperture 894. A filter 880 may be associated with each LED in the light source. Acceptable filters may be obtained from CVI Laser of Albuquerque, NM under part numbers F10-680.0-4, F10-720.0-4, F10-760.0-4 and F10-800

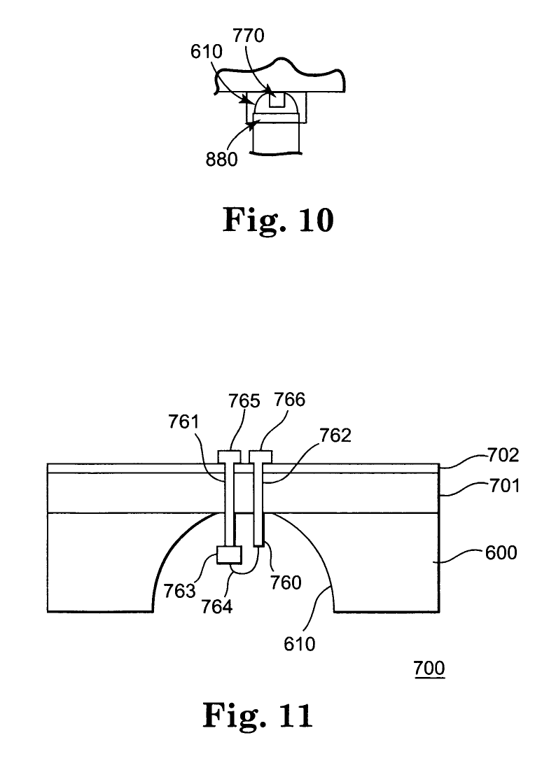

Referring now to FIG. 11, thereshown is an exploded view of light source 700 and in particular, the LED 770 in a parabolic hole. LED 770 is, in one embodiment, made from a positive post 762, ground post 761, light emitting diode material 763, wire 764 and pads 765 and 766. In one embodiment, posts 761 and 762 are gold plated copper posts while wire 764 is Gold Ball Bond (GBB) wire. The diode material may be attached to post using a conductive epoxy. Traces 702 on circuit board 701 are used to provide appropriate electrical signals to the LED to cause electricity to flow therethrough. In one embodiment, the one LED is operated to produce radiation at a center wavelength of 800 nm, a second LED is operated at a center wavelength of 760 nm, a third is operated at a center wavelength of 720 nm and a fourth is operated at a center wavelength of 680 nm. LEDs at or near these values are available from Three Five Compounds, Inc. of Elmhurst, NY under part numbers TF805/E3, TF760/E3, TF730/E3 and TF680. Referring now to FIG. 12, thereshown is a perspective view of a reflector 600 ′ for four LEDs. Note that the present reflector does not include any recessed areas. Also note that the parabolic holes 610 are at an angle to the plane of major surface 620. This is in order to again set the central axis of the parabolic holes to be directed to a common point.

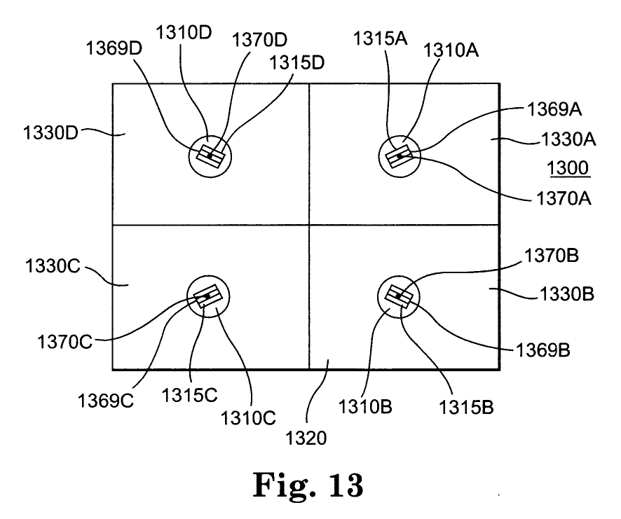

Referring now to FIG. 13, thereshown is another embodiment of the inventive light source, 1300. Light source 1300 includes reflector body 1320 having concave surfaces 1310A-D, holes 1315A-D in concave surfaces 1310A-D, mounting regions 1330A-D, LEDs 1370A-D mounted on circuit board bridges 1369A-D. In one embodiment, the concave surfaces are formed as parabolas. In another embodiment, the concave surfaces are formed as ellipses. In the present embodiment, the concave surfaces cooperate with the circuit board to position the LEDs in the proper location and at the proper depth with regard to the concave surfaces to provide for the desired amount of redirection of light in a particular direction.

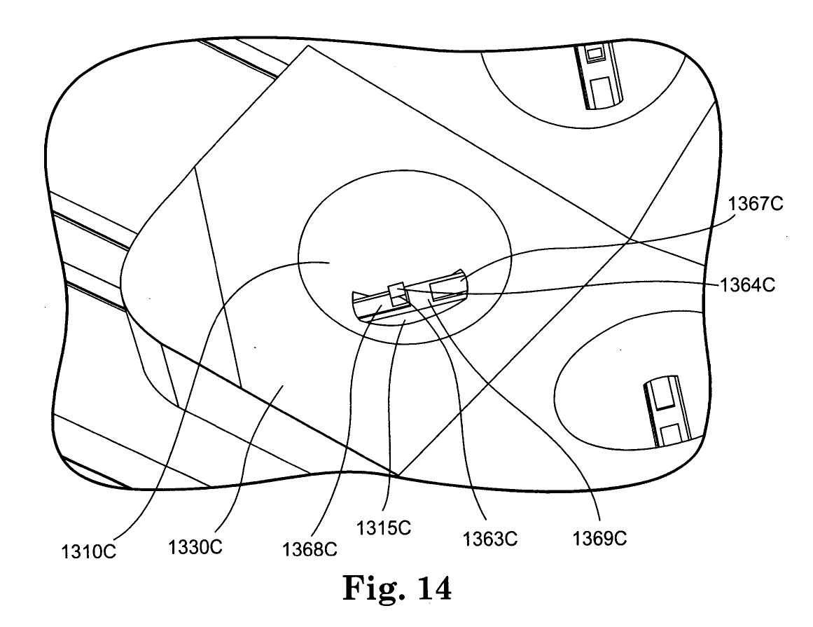

As can be seen in FIG. 14, a close up view of the light source in FIG. 13, particularly around mounting feature 1330C, is shown. Here, a more detailed view of the circuit board bridge and the LED can be seen. In particular, the LED 1370C is seen to be made from diode material 1363C formed on lead 1368C. A wire 1364C completes the electrical path to lead 1367C. Note that circuit board bridge 1369C, extends into the concave surface 1310C and that in the case of a parabolic concave surface, diode material 1363C is placed at the focal point of the parabola. In one embodiment, the reflector body 1320 sits on a grounded lead while the reflector is not in contact with charged leads.

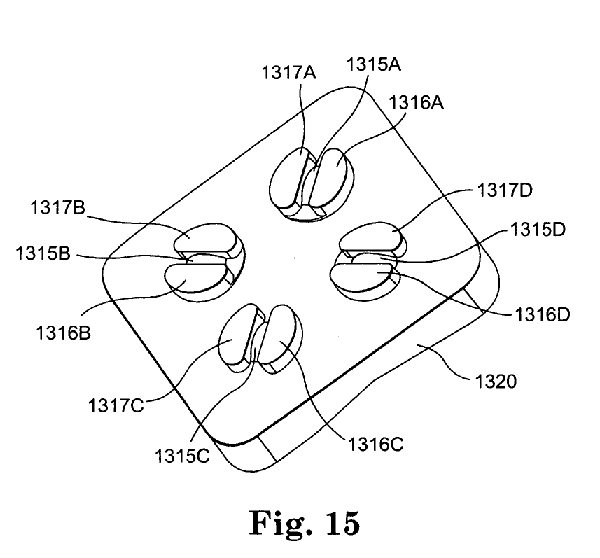

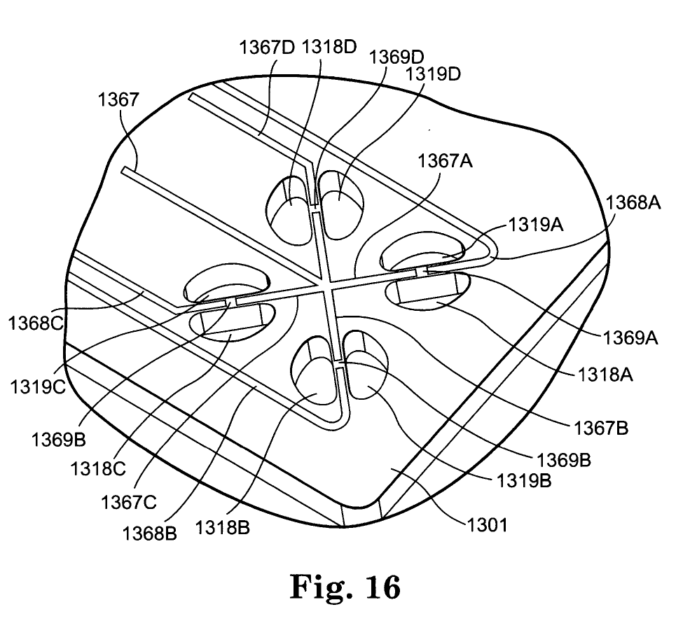

Referring now to FIGS. 15 and 16, thereshown is a perspective view of the reverse side of a reflector body 1320 and a top perspective view of a circuit board 1301. Each concave surface 1310A-D is associated with first and second protrusions 1316A-D and 1317A-D. Further, circuit board 1301 has first and second holes 1318A-D and 1319 A-D that correspond with the first and second protrusions 1316A-D and 1317A-D. Note that the shape of the protrusions does not necessarily have to match the shape of the concave surface. However, in one embodiment, the shape and size of the protrusions 1316A-D and 1317A-D match the size and shape of first and second holes 1318A-D and 1319A-D of the circuit board. Between the first and second protrusions 1316A-D and 1317A-D are holes 1315A-D respectively that allow the circuit board bridges 1369A-D as well as leads 1367A-D and 1368A-D to communicate with the inside of concave surfaces 1310A-D. Note that the LEDs are not shown on circuit board 1301. Common lead 1367 connects together leads 1367A-D and may be a ground lead.

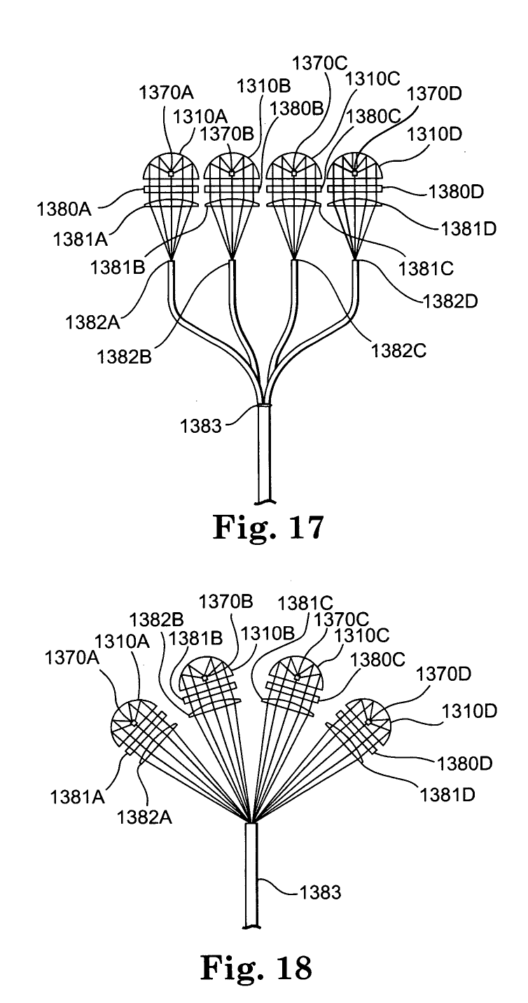

Referring now to FIGS. 17 and 18 thereshown are two different light delivery methods using the light source 1300 of FIG. 13. FIG. 17 shows a structure for delivering light to fibers for presentation at the tissue surface where there is no common point of intersection of the axes for the concave surfaces. Each LED 1370A-D is located in its own concave reflector 1310A-D respectively. Light produced by the LED is redirected to interference filter 1381A-D which filters out light in accordance with its optical characteristics. Next, the light is focused on fibers 1382A-D by lenses 1381A-D. Fibers 1382A-D merge into fiber 1383 where the light from the LEDs is mixed.

Alternatively, the light from the LEDs can be focused on the mixing fiber 1383 directly, thereby leaving out fibers 1382A-D.

FIGS. 8A and 8B and 9A and 9B show optical heads having the LED light direction scheme shown in FIGS. 17 and 18

By structuring a lighting structure to include a reflector that redirects light through an interference filter and lens in this way, much of the receive side optics used in the prior art can be eliminated.

All patents, patent applications, and publications cited herein are hereby incorporated by reference in their entirety as if individually incorporated.

Although the present invention has been described in terms of particular embodiments, one of ordinary skill in the art, in light of this teaching, can generate additional embodiments and modifications without departing from the spirit of or exceeding the scope of the claimed invention. The foregoing description has been offered by way of example, not limitation. The applicant describes the scope of his invention through the claims appended hereto.

1. A reflector for a light source comprising a structure having a first surface, the first surface having a first concave hole for collimating light formed therein, the concave hole being sufficiently large such that the light source is a point source relative to the concave hole.

2. The reflector of claim 1, wherein said concave hole is shaped at least in part as a parabola.

3. The reflector of claim 2, wherein said concave hole is a paraboloid.

4. The reflector of claim 1 further comprising a second concave hole for collimating light.

5. The reflector of claim 4 wherein each of the first and second concave holes have a central axis therethrough, and wherein the central axis of the first and second concave holes intersect.

6. The reflector of claim 5, wherein the reflector has third and fourth concave holes for collimating light and wherein each of the first through fourth concave holes have a central axis therethrough, and wherein the central axis of the first through fourth concave holes intersect.

7. The reflector of claim 6, wherein the first through fourth concave holes are each shaped at least in part as parabolas.

8. The reflector of claim 7, wherein the first through fourth concave holes are each shaped at least in part as paraboloids.

9. A lighting structure comprising:
a) a reflector having a first concave hole formed therein; and
b) a first light source in the first concave hole.
c) a first filter positioned so that at least a portion of the light from the first light source passes therethrough.

10. The lighting structure of claim 9, wherein the first light source is a first light emitting diode.

11. The lighting structure of claim 10, wherein the first concave hole is a first parabolic hole shaped at least in part as a parabola.

12. The lighting structure of claim 11, wherein the first light emitting diode has a centroid and wherein the first parabolic hole has a first axis and a shape substantially in the form of y=Ax², the centroid being placed at a point along the axis from a bottom of the parabolic hole substantially at the distance of ¼ A.

13. The lighting structure of claim 11, further comprising:
a) a second parabolic hole formed in the reflector;
b) a second light emitting diode in the second parabolic hole; and
c) a second filter positioned so that at least a portion of the light from the second light emitting diode passes therethrough.

14. The lighting structure of claim 13, wherein the first and second light emitting diodes each have a centroid and wherein the first and second parabolic holes have a first and second axis respectively, and a shape substantially in the form of y=Ax², the centroid each being placed respectively at a point along the first and second axis from a bottom of the first and second parabolic holes substantially at the distance of ¼ A.

15. The lighting structure of claim 14, wherein the first and second axes substantially intersect.

16. The lighting structure of claim 11 wherein the reflector has a mounting region for the filter, the filter being associated with the mounting region.

17. The lighting structure of claim 16 wherein, wherein the first light emitting diode has a centroid and wherein the first parabolic hole has a first axis and a shape substantially in the form of y=Ax², the centroid being placed at a point along the axis from a bottom of the parabolic hole substantially at the distance of ¼ A.

18. The lighting structure of claim 13 wherein the reflector has a first mounting region for the first filter and a second mounting region for the second filter.

19. The lighting structure of claim 18, wherein the first and second light emitting diodes each have a centroid and wherein the first and second parabolic holes have a first and second axis respectively and a shape substantially in the form of y=Ax², the centroid each being placed respectively at a point along the first and second axis from a bottom of the first and second parabolic holes substantially at the distance of ¼ A.

20. An illumination system, comprising:
a) a reflector having a first surface at least in part in the shape of a parabola, the parabola having a first axis therethrough;
b) a first light source located substantially at the focal point of the parabola;
c) an optical filter arranged with respect to the light source such that at least a portion of the light from the light source passes therethrough.

21. The illumination system of claim 20, wherein the optical filter has a major surface arranged normal to the axis.

22. The illumination system of claim 20, further comprising:
a) a second surface at least in part in the shape of parabola, the parabola having a second axis therethrough;
b) a second light source in the second surface; and
c) a second filter positioned so that at least a portion of the light from the second light source passes therethrough.

23. The illumination system of claim 22, wherein the first and second light sources each have a centroid and wherein the parabolic portions of the first and second surfaces have a first and second axis respectively, and a shape substantially in the form of y=Ax², the centroid each being placed respectively at a point along the first and second axis from a base of the first and second parabolic portions of the first and second surfaces substantially at the distance of ¼ A.

24. The illumination system of claim 22, wherein the first and second axes substantially intersect.

25. The illumination system of claim 24 wherein the first and second surfaces have first and second mounting regions, respectively, for the first and second filters, the first and second filters being associated with the first and second mounting regions.

26. The illumination system of claim 23, wherein the first and second light emitting diodes each have a centroid and wherein the first and second parabolic holes have a first and second axis respectively and a shape substantially in the form of y=Ax², the centroid each being placed respectively at a point along the first and second axis from a bottom of the first and second parabolic holes substantially at the distance of ¼ A.

27. The illumination system of claim 20, further comprising a lens arranged such that a least a portion of the light passing through the optical filter passes through the lens.

28. The illumination system of claim 20, further comprising a mounting surface normal to the central axis, the optical filter being associated with the mounting surface.

29. An illumination system, comprising:
a) a plurality of light emitting diodes;
b) a reflector for each light emitting diode, the reflector adapted to receive light from the light emitting diode therein and shaped to direct the light, the reflectors each having an axis, the axes arranged to intersect at a common point.

30. The illumination system of claim 29, wherein the reflectors include a reflective surface shaped as a paraboloid.

31. The illumination system of claim 30, wherein the light emitting diodes are located at the focal points of the paraboloids.

32. The illumination system of claim 31, wherein the reflectors include a surface normal to the axes.

33. The illumination system of claim 32, further comprising an optical filter for each reflector arranged such that at least a portion of the light from the light emitting diode passes therethrough.

34. The illumination system of claim 33, further comprising a lens for each reflector arranged such that at least a portion of the light passing through the optical filter passes through the lens.

35. The illumination system of claim 29, wherein the reflector directs the light by collimating the light.

36. A light based measurement system comprising:
a) a light source including a first light emitting diode and a reflector, the reflector having a substantially parabolic hole formed therein, the first light emitting diode being located in the first parabolic hole, the light source producing light at a plurality of wavelengths within a desired wavelength range;
b) a light sensor for receiving light signals from the light source; and
c) a processor for determining a spectral response based upon received light signals.

37. The light based measurement system of claim 36, wherein the light source and the light sensor are located in a shared package.
